(19) United States
(12) Patent Application Publication
(10) Pub. No.: US 2026/0111571 A1
(43) Pub. Date: Apr. 23, 2026

(54) PERSISTING A STATE OF A VIRTUAL SECURITY PROCESSOR

(71) Applicant: Hewlett Packard Enterprise Development LP, Spring, TX (US)

(72) Inventors: Jean Snyman, Bristol (GB); Geoffrey Ndu, Bristol (GB); Nigel John Edwards, Bristol (GB)

(21) Appl. No.: 19/039,022

(22) Filed: Jan. 28, 2025

Related U.S. Application Data
(60) Provisional application No. 63/708,295, filed on Oct. 17, 2024.

(51) Int. Cl. G06F 21/60; G06F 21/53

(52) U.S. Cl. CPC G06F 21/602; G06F 21/53; G06F 21/604

(57) ABSTRACT

In some examples, a secure service module that provides security services for a virtual compute entity requests a key from a processor. A system encrypts a state of a virtual security processor using the key to produce an encrypted virtual security processor state, and the system stores the encrypted virtual security processor state in a persistent storage.

### CROSS REFERENCE TO RELATED APPLICATION

This application claims the benefit under 35 U.S.C. § 119(e) of U.S. Patent Provisional Application No. 63/708,295, titled “Persisting a State of a Virtual Security Processor,” filed Oct. 17, 2024 (Attorney Docket No. P175802PRV), which is hereby incorporated by reference.

### BACKGROUND

Programs can execute in a computing environment. In some cases, the computing environment may be operated by a service provider, and the programs can belong to one or more tenants of the computing environment. The tenants may be part of organizations that are different from the service provider.

### BRIEF DESCRIPTION OF THE DRAWINGS

Some implementations of the present disclosure are described with respect to the following figures.

FIG. 1 is a block diagram of a physical platform, according to some examples.

FIG. 2 is a block diagram of privilege levels according to some examples.

FIG. 3 is a flow diagram of an initial virtual trusted platform module (vTPM) state export process according to some examples.

FIG. 4 is a flow diagram of a vTPM state restore process according to some examples.

FIG. 5 is a block diagram of a storage medium storing machine-readable instructions according to some examples.

FIG. 6 is a block diagram of a system according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Trusted execution environments (TEEs) provided by modern central processing units (CPUs) unlock the ability to execute trusted code (e.g., trusted software or other trusted machine-readable instructions) on a physical platform (including hardware as well as machine-readable instructions) belonging to an untrusted party. Trusted code includes code whose data is encrypted and protected against unauthorized access. Due to the use of memory encryption, the owner of the physical platform has no visibility into the trusted code's running state, including any confidential data the trusted code may be processing. Other code running on the same physical platform also have no visibility to the trusted code's running state. Thus, the trusted code of a first entity may be run in a virtual machine (VM) on the hardware platform with confidence that the running state of the trusted software is protected against unauthorized access by other entities, such as other tenants using the physical platform, a hypervisor, a service provider (e.g., a cloud service provider (CSP)) operating the physical platform, or any other entity. In other words, the other entities have no more access to the trusted code's running state than if the trusted code were running in the first entity's own premises. VMs protected by a TEE are referred to as confidential VMs (CVMs).

These security guarantees may come with conditions and restrictions. While data of the trusted code is protected, achieving persistence of that data so that the persisted data may be accessed at a later time may be difficult. The data of the trusted code may be encrypted using a data encryption key, which may be stored in a protected memory. In some cases, the data encryption key can be stored in the protected memory of a virtual Trusted Platform Module (vTPM) in a Secure VM Service Module (SVSM) in a CVM. The SVSM in the CVM provides security services to various entities in the CVM. A data encryption key held in the vTPM in the SVSM may be lost due to a reset (e.g., a reboot or shut down) of the CVM by a hypervisor.

In accordance with some implementations of the present disclosure, a state of a virtual security processor, such as a vTPM, in a secure service module (e.g., an SVSM) in a CVM (or another type of virtual compute entity) can be persisted by encrypting the state using a processor-generated key (e.g., a key generated by the CPU). The encrypted state of the virtual security processor can be stored in a persistent storage. The processor-generated key may be requested by the secure service module such as the SVSM and used to encrypt the state of a virtual security processor. The state of a virtual security processor can include a data encryption key used to encrypt data of a trusted code in a physical platform. When the CVM (or another type of virtual compute entity) is reset (e.g., rebooted or shut down), the encrypted state of the virtual security processor stored in the persistent storage is not lost. After the reset of the CVM (or another type of virtual compute entity), the encrypted state of the virtual security processor can be retrieved and decrypted using the processor-generated key to produce a decrypted state of the virtual security processor. The data encryption key can then be obtained from the decrypted state of the virtual security processor to enable decryption of encrypted data of the trusted code.

A CVM is a VM protected by a TEE, and the CVM can encrypt data of the trusted program using a data encryption key before saving the encrypted data to a storage system. The ability to retrieve the encrypted data of the trusted code depends on availability of the data encryption key. If the data encryption key is lost, such as due to a reset of a CVM in which the trusted code executes, then the encrypted data of the trusted code would not be recoverable. In some examples, the data of the trusted code is held in a storage volume (also referred to as a “storage disk”) of the trusted code. The storage volume (or storage disk) can refer to any container of data accessible to the trusted code. Note that the storage disk is a virtual storage disk since the trusted code can be executed by a virtual compute entity, e.g., a CVM. In other examples, the trusted code may be executed by another type of virtual compute entity, such as a container.

As noted above, encryption keys for encrypting data of trusted code may be stored in a vTPM. In examples where trusted code are provided in CVMs, the encryption keys may be stored in a vTPM provided by an SVSM, which is an entity that provides security services to other higher-level entities in a CVM. Because the SVSM also runs within the TEE, the vTPM in the SVSM is subject to the same issue of encryption keys held in the vTPM being lost when the CVM is shut down.

A TPM is an example of a security processor (sometimes referred to as a security crytpoprocessor) that can perform various hardware-based, security functions in a physical platform. The security functions of the security processor can include key and certificate management and generation. For example, the security processor can generate cryptographic keys used in security operations, where a cryptographic key can include a public-private key pair including a public key and the associated private key.

A vTPM is a virtual version of a TPM. A physical TPM is a discrete chip implemented with a combination of software and firmware (machine-readable instructions) running in the discrete chip. The vTPM is implemented using machine-readable instructions and runs on a processing resource (e.g., a CPU or another type of processing resource such as a management controller) that is shared with other software or firmware carrying out other functions.

A TPM state of a TPM (either a physical TPM or a vTPM) can refer to certain information stored in a memory region of the TPM. For example, the TPM state can include a seed used to derive keys. A seed is an initial value from which other secrets such as keys can be derived. The TPM state can also include an encryption key used to encrypt data.

Persisting the TPM state refers to making the TPM state persistent so that the TPM state is not lost after a reset of the CVM. The TPM state can be persistently stored in a persistent storage, and the TPM state can be recovered after the reset of the CVM.

In some examples, keys can be made available to CVMs by an external service known as a key broker. The key broker identifies, and verifies the state of, the specific TEE in which a CVM is running. If this succeeds, the key broker delivers the CVM's encryption key to the CVM over a secure channel. Use of the key broker overcomes the issue of loss of encryption keys when the CVM is rebooted.

Although the use of a key broker is workable for some systems, other systems are built to perform cryptographic operations using a TPM specifically, often during the initialization or boot of the operating system. For example, the BitLocker feature in Windows operating systems (OSes) encrypts the entire system volume using keys held in the system's TPM. As a result, for a system running the Windows OS to operate properly, a TPM with a persistent state is to be provided. It is not possible to provide the key from a key broker after the boot of the OS—the key is to be provided during boot in order to load the OS from the encrypted system volume.

Although reference is made to using a TPM with a persistent state with Windows OSes, in other examples, it may be desirable to persist TPM states in other contexts.

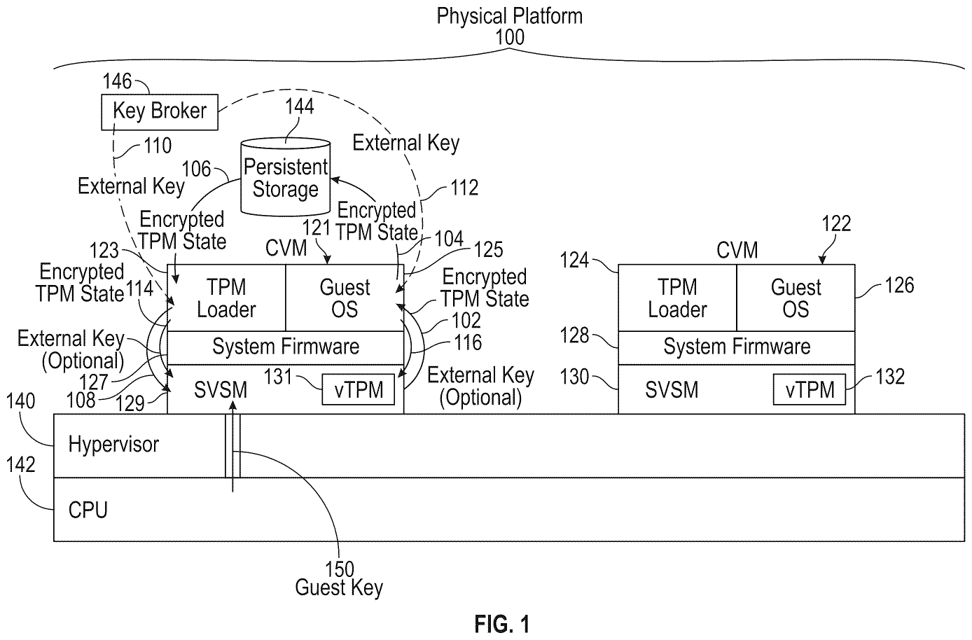

FIG. 1 shows an example physical platform 100 that includes CVMs 121 and 122. In other examples, the physical platform 100 can include just one CVM or more than two CVMs. The physical platform 100 can be implemented with one or more computers.

Each CVM includes a TPM loader, a guest operating system (OS), an OS bootloader, Unified Extensible Firmware Interface (UEFI) code (or more generally, system firmware), and an SVSM. Each CVM defines a respective TEE (trusted execution environment) in which components of the CVM execute. Within a TEE, the data in memory is encrypted so that nothing outside the TEE (CVM) is able to decipher the encrypted data.

The CVM 121 includes a TPM loader 123, a guest OS 125, an OS bootloader (not shown), system firmware 127, and an SVSM 129. Similarly, the CVM 121 includes a TPM loader 124, a guest OS 126, an OS bootloader (not shown), system firmware 128, and an SVSM 130.

As further shown in FIG. 1, the SVSM 129 includes a vTPM 131, and the SVSM 130 includes a vTPM 132. A vTPM in an SVSM has information stored in a memory region of the vTPM; this information is part of the state of the vTPM (referred to as a “vTPM state”). The vTPM state can contain one or more encryption keys used to encrypt data of one or more trusted code executed in the CVM. A trusted code in a CVM can include application software in the CVM, the system firmware in the CVM, or any other code in the CVM.

In an example, the vTPM state of the vTPM 131 can contain one or more encryption keys used to encrypt data of one or more trusted code executed in the CVM 121. Similarly, the vTPM state of the vTPM 132 can contain one or more encryption keys used to encrypt data of one or more trusted code executed in the CVM 122. The vTPM state of a vTPM can further include other information.

An OS bootloader is used to boot a guest OS in a CVM. A TPM loader performs initialization of a vTPM. For example, the TPM loader 123 can initialize the vTPM 131 in the SVSM 129, and the TPM loader 124 can initialize the vTPM 132 in the SVSM 130. In some examples, a TPM loader can be implemented as a lightweight single-purpose service OS, an initial RAM (random access memory) disk (initrd) program, or a firmware component. A single-purpose service OS is an OS configured to perform a targeted function, which in this case is the initialization of a vTPM. An initrd program can mount a RAM disk (or more generally, a storage volume) as a root file system, and programs (e.g., a vTPM) can be run from the RAM disk. If the TPM loader is implemented as a firmware component, the firmware component may include a UEFI application found in an unencrypted EFI system partition of a storage system. If UEFI Secure Boot is enabled, this UEFI application is signed by a key that is added to the firmware's list of trusted keys.

The CVMs 121 and 122 are run above a hypervisor 140. Running a CVM “above” the hypervisor 140 refers to running the CVM in an execution environment created by the hypervisor 140. The hypervisor 140 creates and manages VMs, including the CVMs 121 and 122. The hypervisor 140 executes on a CPU 142, which includes one or more hardware processors. The CPU 142 is part of the hardware layer of the physical platform 100. In some examples, the CPU 142 can be an Advanced Micro Devices (AMD) CPU, an Intel CPU, or a CPU from another vendor.

An SVSM (e.g., 129 or 130) is designed to have minimal interactions with the other entities in the CVM in which the SVSM is deployed, and the SVSM has no direct interaction with entities outside the CVM. For example, the SVSM is isolated from the guest OS in the CVM. The SVSM is also isolated from a host OS that runs in the physical platform 100 and is outside the CVM. Also, the SVSM is isolated from the hypervisor 140. Because of this isolation, the SVSM does not have any network services.

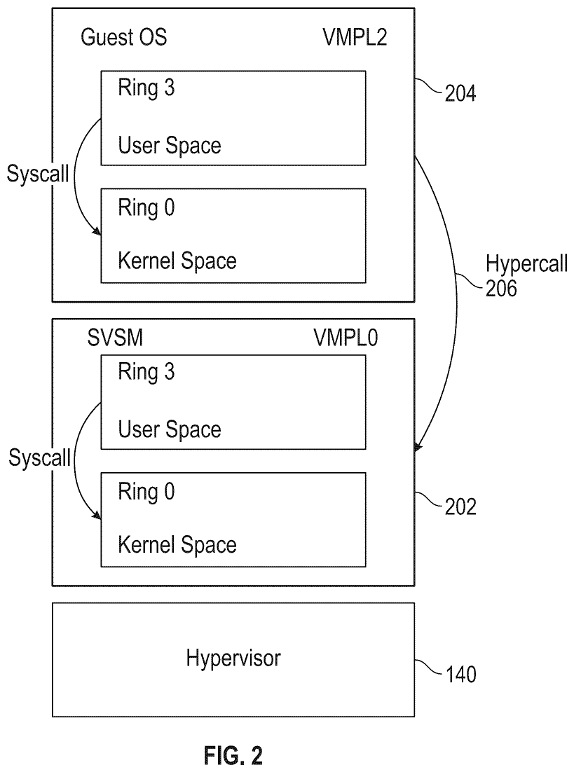

The CPU can define privilege levels such as an OS kernel privilege level (ring 0) and a user privilege level (ring 3). A privilege level at which a program executes defines access rights of the program (e.g., which resources are accessible by the program, what interactions with the resources are allowed, or other access rights). In addition, the CPU can define additional VM privilege levels of the TEE. The VM privilege levels can include VM privilege level 0 and other VM privilege levels, such as VM privilege levels 1, 2, and 3, for example. In further examples, there may be more than four VM privilege levels or less than four VM privilege levels. A VM privilege level defines access rights for a program running in a VM. The SVSM can run at VM privilege level 0, which is the most privileged VM privilege level. The SVSM is isolated and protected from layers of the CVM above the SVSM, including system firmware, the guest OS, virtual compute entities, and other programs. Example privilege levels are shown in FIG. 2. The other entities of the CVM may be run at a less privileged VM privilege level (e.g., 1, 2 or 3) that is less privileged than VM privilege level 0.

In accordance with some implementations of the present disclosure, a state of a virtual security processor, such as the vTPM 131 in the CVM 121, can be persisted based on encrypting the vTPM state using a processor-generated key (e.g., a key generated by the CPU 142). The processor-generated key is provided by the CPU 142 in response to a request from the SVSM 129 in the CVM 121.

The processor-generated key is represented as a guest key 150 in FIG. 1. The guest key 150 is sent by the CPU 142 to the SVSM 129 in the CVM 121, while bypassing the hypervisor 140. Note that the guest key 150 is part of encrypted data that cannot be deciphered by the hypervisor 140, so the hypervisor 140 would be unable to derive the guest key 150. The SVSM 129 uses the guest key 150 as the TPM state key to encrypt the memory locations of the vTPM that are specified as non-volatile by the TPM 2.0 standard. It uses an authenticated encryption algorithm to perform this operation to ensure that the vTPM's state cannot be modified without detection after leaving the SVSM 129.

In response to a request from the SVSM 130 in the CVM 122, the CPU 142 can similarly provide the guest key 150 to the SVSM 130 to encrypt a vTPM state of the vTPM 132 in the CVM 122.

The encrypted state of the security processor, such as the encrypted vTPM state, can be written to a persistent storage 144, which is outside the CVM 121. For example, the SVSM 129 encrypts the vTPM state of the vTPM 131 using the guest key 150, and sends (at 102) the encrypted TPM state to the guest OS 125. The guest OS 125 exports the encrypted vTPM state by writing (at 104) the encrypted vTPM state to the persistent storage 144. At a later time (e.g., after a reset of the CVM 121), the TPM loader 123 can import (at 106) the encrypted TPM state (if available) from the persistent storage 144. The TPM loader 123 then provides (at 108) the encrypted vTPM state to the SVSM 129, which can decrypt the encrypted vTPM state.

Similar tasks may be performed by the SVSM 130, the guest OS 126, and the TPM loader 124 of the CVM 122 for persisting the encrypted vTPM state of the VTPM 132 to the persistent storage 144, and later loading the encrypted vTPM state for decryption by the SVSM 130.

In alternative examples, the TPM state key used to encrypt the vTPM state of a vTPM can be based on a combination of the guest key 150 and other information. For example, the other information can include an external key provided by a key broker 146. In some examples, the key broker 146 is part of the physical platform 100. In other examples, the key broker 146 may be external of the physical platform 100. In examples where the key broker 146 is provided, the TPM state key may be derived based on a combination of the guest key 150 and the external key from the key broker 146.

The combination of the guest key 150 and the external key can include an XOR operation applied to the guest key 150 and the external key, a hash function applied on the guest key 150 and the external key, or any other combination of the guest key 150 and the external key.

The key broker 146 may provide (at 110) the external key to the TPM loader 123 and/or the key broker 146 may provide (at 112) the external key to the guest OS 125 in the CVM 121. Similarly, the key broker 146 may provide the external key to the TPM loader 124 and/or the guest OS 126 in the CVM 122.

The TPM loader 123 can provide (at 114) the external key to the SVSM 129 in the CVM 121. In some cases, the guest OS 125 can provide (at 116) the external key to the SVSM 129. In the CVM 122, the TPM loader 124 can provide the external key to the SVSM 130, and the guest OS 125 can provide the external key to the SVSM 130. The SVSM 129 or 130 can combine the guest key 150 and the external key to produce the TPM state key for encrypting a vTPM state.

In some examples of the present disclosure, a boot of a CVM can be performed in two phases: (1) a TPM loading phase performed by the TPM loader, and (2) an OS boot phase performed by the OS bootloader. In other examples, a two-phase boot of the CVM is not performed—rather, when a guest OS is loaded in a CVM, the guest OS can send a request to the SVSM to persist a state of a virtual security processor, e.g., a vTPM.

The ensuing discussion refers to examples where the two-phase boot is used. The discussion refers to the CVM 121. Similar tasks can be performed with the other CVM 122. When the CVM 121 is started, the system firmware 127 boots from a first virtual disk and completes the first phase before performing a system reset and booting from a second virtual disk to complete the second phase. A “virtual disk” can refer to a storage volume used by a virtual compute entity such as a VM or a container.

In the first phase, the TPM loader 123 initializes the vTPM 131. The TPM loader 123 further initializes the CVM 121 in preparation for the second phase in which the guest OS 125 of the CVM 121 is booted.

FIG. 2 is a block diagram of an arrangement including the hypervisor 140, an SVSM 202, and a guest OS 204. The SVSM 202 and the guest OS 204 are part of a CVM, which can be either the CVM 121 or 122 of FIG. 1.

The SVSM 202 runs at VM privilege level 0 (VMPL0), and the guest OS 204 runs at VM privilege level 2 (VMPL2), which is less privileged and thus has less access rights than VM privilege level 0. In other examples, the SVSM 202 and the guest OS 204 can be run at other VM privilege levels, provided the VM privilege level of the guest OS 204 is less privileged than the VM privilege level of the SVSM 202.

In some examples, the guest OS 204 can interact with the SVSM 202 by issuing a hypercall 206 to the SVSM 202. A hypercall is a CPU instruction to invoke a function running at a more privileged level. The hypercall 206 invokes a function (at the SVSM 202) with a privilege level switch. In other examples, the guest OS 204 at a first VM privilege level can communicate with the SVSM at a different second VM privilege level using a different type of interface.

In some examples, the guest OS 204 has multiple privilege levels, including an OS kernel privilege level (ring 0) and a user privilege level (ring 3). An application software running in an environment defined by the guest OS 204 can execute at the ring 3 privilege level. The kernel of the guest OS 204 executes at the ring 0 privilege level. The application software executing at the ring 3 privilege level can interact with the kernel by issuing a syscall, which is a system call used by the application software to request a service from the kernel.

In some examples where the SVSM 202 is implemented as a single-purpose service OS, the SVSM 202 also has multiple privilege levels, including the ring 3 and ring 0 privilege levels. In other examples, the SVSM 202 is implemented as an initrd program or a firmware component, in which case the concept of ring 3 and ring 0 privilege levels are not implemented.

### Initial vTPM State Export

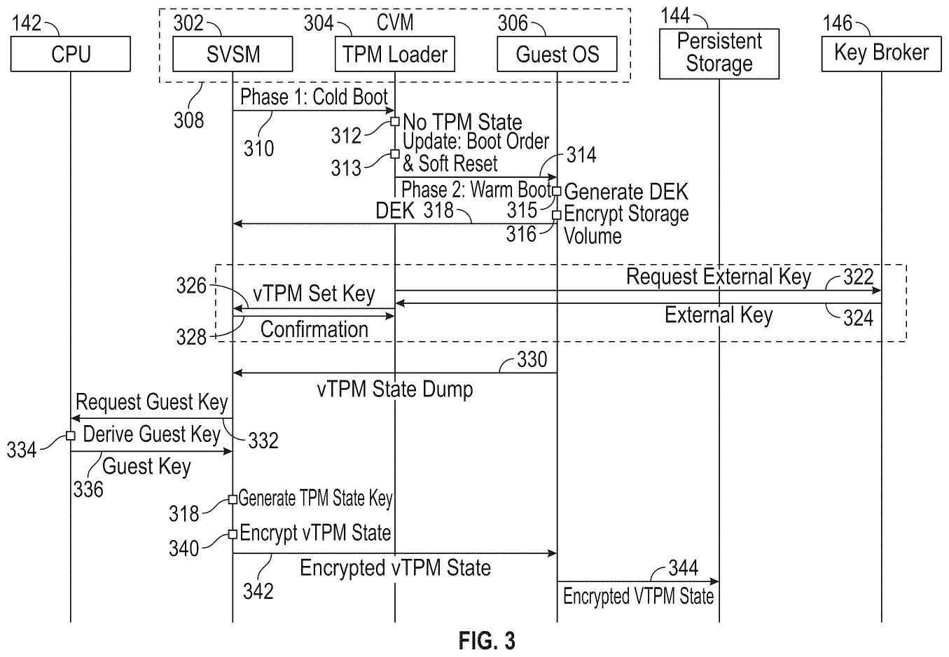

FIG. 3 is a flow diagram of an example initial vTPM state export process, which involves the CPU 142, an SVSM 302, a TPM loader 304, a guest OS 306, the persistent storage 144, and the key broker 146. The SVSM 302 may be the SVSM 129 or 130 of FIG. 1, the TPM loader 304 may be the TPM loader 123 or 124 of FIG. 1, and the guest OS 306 may be the guest OS 125 or 126 of FIG. 1. The SVSM 302, the TPM loader 304, and the guest OS 306 are part of a CVM 308. In some examples, the key broker 146 may be omitted.

In some examples, a boot of the CVM 308 can be performed in two phases: (1) a TPM loading phase (phase 1) performed by the TPM loader 304, and (2) an OS boot phase (phase 2) performed by an OS bootloader that is part of an OS environment that also includes the guest OS 306. In phase 1, a cold boot (at 310) of the CVM 308 is performed, which causes the TPM loader 304 to launch. The TPM loader 304 checks its virtual disk for presence of a vTPM state file). If this is a first boot of the CVM 308, the TPM loader 304 detects (at 312) that there is no existing vTPM state file. The vTPM state file if present indicates that a vTPM state was previously set up in the vTPM. In response to detecting that there is no existing vTPM state file, the TPM loader 304 changes (at 313) a firmware boot order to replace the TPM loader's virtual disk with the virtual disk of the guest OS 306, and performs a soft reset of the CVM 308. Changing the firmware boot order can be performed by updating variables (e.g., EFI variables) of the system firmware of the CVM 308.

The soft reset triggers a warm boot (at 314) of the CVM 308, which starts phase 2. In phase 2, the system firmware (e.g., UEFI firmware) of the CVM 308 loads the OS bootloader instead of the TPM loader 304. The OS bootloader boots the guest OS 306.

The SVSM 302 can initialize the vTPM state of a vTPM in the SVSM 302, such as by initializing a seed of the vTPM. The vTPM provided by the SVSM is available to the guest OS 306. The guest OS 306 generates (at 315) a data encryption key (DEK), and the guest OS 306 encrypts (at 316) a storage volume of the CVM 308 using the DEK. The guest OS 306 saves (at 318) the DEK to the vTPM in the SVSM 302. The DEK is saved as part of the vTPM state of the vTPM.

Note that if the physical platform were to reboot at this point, the content of the vTPM (the vTPM state) would be lost. To address this issue, a user (or another entity) can cause an encrypted version of the vTPM state to be persisted in accordance with some examples of the present disclosure, such as by exporting the encrypted vTPM state to the persistent storage 144.

To persist the encrypted vTPM state, an SVSM driver loaded by the guest OS 306 can issue (at 330) a vTPM state dump command to the SVSM 302, such as by using a hypercall to the SVSM 302. The hypercall is a CPU instruction to invoke a function running at a more privileged level. For example, the SVSM driver in the guest OS 306 may run at VM privilege level 1 or 2 or 3. The vTPM state dump command issued from the guest OS 306 to the SVSM 302 invokes a function at a more privileged level (e.g., VM privilege level 0) at the SVSM 302. The hypercall invokes a function (at the SVSM 302) with a privilege level switch.

The vTPM state dump command is a command requesting the SVSM 302 to export and persist the vTPM state (or more specifically, an encrypted version of the vTPM state). In response to the vTPM state dump command, the SVSM 302 requests (at 332) a guest key from the CPU 142. The CPU 142 derives (at 334) the guest key from one or more values, including any or some combination of the following: a launch measurement of the CVM 308; a cryptographic key associated with the CPU 142; a privilege level of the CVM 308; or other CVM attributes.

The launch measurement of the CVM 308 can include a measurement (a hash value produced by a cryptographic hash function) of machine-readable instructions of the CVM image, including machine-readable instructions of the SVSM 302, the vTPM in the SVSM 302, and system firmware (e.g., UEFI firmware) in the CVM 308 that were loaded into memory at launch of the CVM 308.

The cryptographic key may include a versioned chip endorsement key (VCEK) to tie the guest key to a specific CPU (e.g., 142). Alternatively, the endorsement key may include a versioned loaded endorsement key (VLEK) to tie the guest key to a fleet of CPUs. More generally, the cryptographic key may refer to any key used by a CPU (or group of CPUs) to perform a security operation.

Basing the guest key on the privilege level of the SVSM 302 (e.g., VM privilege level 0) ensures that just the SVSM 302 itself (which runs at the most privileged level, e.g., VM privilege level 0) can re-obtain the guest key. Another entity (e.g., an attacker such as malware) running at a different privilege level would not be able to obtain the guest key.

The CPU 142 sends (at 336) the guest key to the SVSM 302. In response to receiving the guest key from the CPU 142, the SVSM 302 generates (at 338) a TPM state key to use in encrypting the vTPM state of the vTPM in the SVSM 302.

In some examples, the generation of the TPM state key includes the SVSM 302 using the guest key provided by the CPU 142 as the TPM state key. In alternative examples, the generation of the TPM state key includes combining the guest key provided by the CPU 142 with an external key from the key broker 146 to generate the TPM state key.

The SVSM 302 encrypts (at 340) the vTPM state using the TPM state key, and the SVSM 302 sends (at 342) the encrypted vTPM state to the guest OS 306. In some examples, the SVSM 302 returns control of the CVM 308 to the guest OS 306 while providing the encrypted vTPM state to the guest OS 306. The guest OS 306 (or another entity) writes (at 344) the encrypted TPM state to the persistent storage 144. For example, the encrypted vTPM state is written to a vTPM state file, such as to a virtual disk of the TPM loader 304 or another storage location that is part of the persistent storage 144.

In examples where the TPM state key is based on a combination of the guest key from the CPU 142 and the external key from the key broker 146, the TPM loader 304 obtains the external key from the key broker 146 by initiating an interaction with the key broker 146. The TPM loader 304 requests (at 322) the external key from the key broker 146. As part of the request, the TPM loader 304 can perform an attestation of the key broker 146 to validate an identity of the key broker 146. In response to the request, the key broker 146 sends (at 324) the external key to the TPM loader 304. The TPM loader 304 sends the external key to the SVSM 302 by issuing (at 326) a vTPM set key command to the SVSM 302, such as by using a hypercall. The vTPM set key command is a command that requests generation of the TPM state key using the external key. The SVSM 302 sends (at 328) a confirmation to the TPM loader 304 that the vTPM set key command has been received and the SVSM 302 will use the external key in generating the TPM state key. The confirmation can include a message, an information element, or any other indicator.

In some example, if the vTPM set key command is received by the SVSM 302, the SVSM 302 combines the guest key with the external key to generate the TPM state key. On the other hand, if the vTPM set key command is not received by the SVSM 302, the SVSM 302 uses the guest key as the TPM state key.

The TPM loader 304 or another entity can load the system firmware (e.g., UEFI code) in the CVM 308, and the system firmware in turn loads the guest OS 306. In some examples, a measurement of (e.g., a hash value based on) the system firmware can be loaded into the vTPM in the SVSM 302. Information associated with the system firmware of the CVM 308 can thus be persisted. In some examples, information associated with the system firmware is loaded as EFI variables. The SVSM 302 can use a firmware state key to encrypt the EFI variables (or more generally system firmware information), and the encrypted system firmware information can be written to the persistent storage 144 along with the encrypted vTPM state. Encrypted EFI variables can be referred to as an encrypted EFI state. The firmware state key used to encrypt the system firmware information can be based on the guest key from the CPU 142. For example, the firmware state key can be the guest key, or alternatively, the firmware state key can be based on a combination of the guest key and other input information, such as information associated with the system firmware.

### Restoring vTPM State

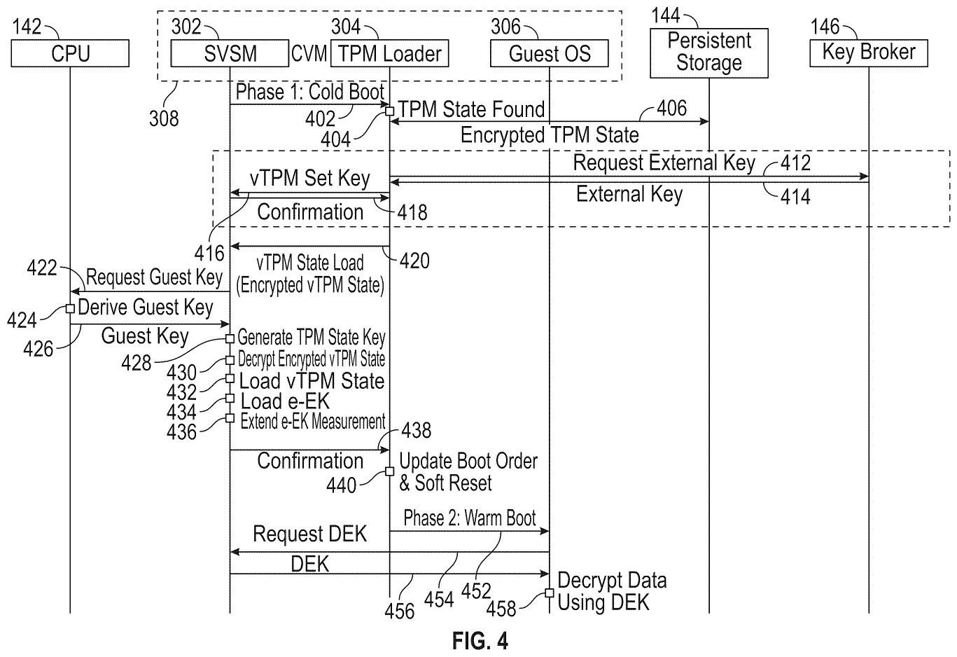

FIG. 4 is a flow diagram of a vTPM state restore process. On a subsequent reset of the physical platform (e.g., hard reset, reboot, power cycle, etc.), a boot of the CVM 308 proceeds in two phases: phase 1 that includes a cold boot (at 402); and phase 2 that includes a warm boot (at 452).

In phase 1, the SVSM 302 (as well as the vTPM in the SVSM 302) loads from scratch. The system firmware in the CVM 308 also loads from scratch. Loading from “scratch” refers to starting a process (e.g., the SVSM 302, the vTPM, and the system firmware) to an initial state in which any prior state is not used. The reset of the CVM 308 clears any vTPM state in the vTPM; additionally, the system firmware information (e.g., EFI variables) is reset to its default state.

The CVM 308 boots the TPM loader 304. When the TPM loader 304 executes, the TPM loader 304 detects (at 404) that the vTPM state file is present on the virtual disk of the TPM loader 304. The presence of the vTPM state file indicates that the vTPM state was set up for the vTPM in the SVSM 302. The vTPM state file may be stored in a known storage location, such as in the persistent storage 144, and the TPM loader 304 may check this known storage location to determine whether the vTPM state file is present.

In response to detecting presence of the vTPM state file, the TPM loader 304 obtains (at 406) the encrypted vTPM state that was previously stored by the guest OS 306 (at 344 in FIG. 3) in the persistent storage 144. After obtaining the encrypted vTPM state, the TPM loader 304 issues (at 420) a vTPM state load command to the SVSM 302, such as by using a hypercall. The TPM loader 304 can provide the content of the encrypted vTPM state file in a request buffer that is made accessible to the SVSM 302, for example.

In response to the vTPM state load command, the SVSM 302 requests (at) the guest key from the CPU 142. The CPU 142 derives (at 424) the guest key from the same one or more values as used in deriving the guest key at 334 in FIG. 3. The CPU 142 then sends (at 426) the guest key to the SVSM 302.

In response to receiving the guest key from the CPU 142, the SVSM 302 generates (at 428) a TPM state key to use in decrypting the encrypted vTPM state. In some examples, the generation of the TPM state key includes the SVSM 302 using the guest key provided by the CPU 142 as the TPM state key. In alternative examples, the generation of the TPM state key includes combining the guest key provided by the CPU 142 with the external key from the key broker 146 to generate the TPM state key. The SVSM 302 can regenerate the same TPM state key as used when the vTPM state was encrypted and stored in FIG. 3, since the TEE of the CVM 308 is unchanged

The SVSM 302 decrypts (at 430) the encrypted vTPM state using the TPM state key. The SVSM 302 loads (at 432) the decrypted vTPM state into the vTPM of the SVSM 302, which includes writing the decrypted vTPM state to a memory of the vTPM. Prior to loading the decrypted vTPM state into the vTPM, the SVSM 302 may clear the memory of the vTPM, and after the clearing of the memory of the vTPM, write the decrypted vTPM state to the memory of the vTPM. The decrypted vTPM state loaded into the memory of the vTPM includes the DEK used to encrypt data by the guest OS 306 for a trusted code in the CVM 308. The decrypted vTPM state also includes other information of the vTPM at the time the vTPM state was exported in FIG. 3.

In some examples, the SVSM may obtain public and private portions of an ephemeral endorsement key (e-EK) belonging to the vTPM and randomly generated when the SVSM 302 started. The e-EK will be used later. An e-EK is a temporary endorsement key that exists for a relatively short time period, such as for as long as the CVM 308 remains operational. Shutting down or resetting the CVM 308 may cause the e-EK to be lost. Note that the e-EK is different from a long-lived EK stored by the vTPM for validating the vTPM. The long-lived EK is part of the vTPM state that is persisted in FIG. 3.

The SVSM 302 loads (at 434) the e-EK into a predefined memory area of the memory of the vTPM. The public and private portions of the e-EK includes an e-EK public key and an e-EK private key, which form a key pair. If a prior e-EK was previously stored in the predefined memory area, the e-EK overwrites the prior e-EK. Loading the e-EK into the vTPM does not overwrite the long-lived EK of the vTPM. The e-EK is another key that is addition to the long-lived EK.

The hypervisor 140 of FIG. 1 may start multiple CVMs from the same CVM image (code of the CVM 308). To distinguish among the multiple CVMs, each respective CVM is assigned a respective e-EK when the respective CVM launches. Different CVMs are assigned different e-EKs. The SVSM 302 writes an e-EK to the vTPM state for a CVM. An e-EK is used for authentication of the CVM. In some examples, the SVSM 302 loads the private portion of the e-EK (the e-EK private key) into the vTPM. This enables the vTPM to later prove possession of this e-EK, which is unique for each CVM instance. More generally, during the restore process, the loaded vTPM state retains ephemeral data (e.g., an e-EK) in the decrypted vTPM state. A new e-EK for each boot of SVSM is loaded into the vTPM.

Next, the SVSM 302 extends (at 436) a specific location of a nonvolatile memory in the vTPM with the e-EK before returning control to the TPM loader 304. The e-EK is measured, e.g., hashed using a hash function such as a cryptographic hash function, and a measurement value (e.g., a hash value produced by the hash function) of the e-EK is extended into the nonvolatile memory in the vTPM. A representation of previous e-EKs and the new e-EK is retained in the persistent state by a rolling hash (extend operation). The extend operation can calculate a hash that is based on the new e-EK and any prior e-EK.

The SVSM 302 sends (at 438) a confirmation to the guest OS 306 that the vTPM state load command has been received and the SVSM 302 has decrypted the encrypted vTPM state.

In response to the confirmation, the TPM loader 304 changes (at 440) a firmware boot order to replace the TPM loader's virtual disk with the virtual disk of the guest OS 306, and performs a soft reset of the CVM 308. Changing the firmware boot order can be performed by updating variables (e.g., EFI variables) of the system firmware.

The soft reset triggers a warm boot (at 452) of the CVM 308, which starts phase 2. In phase 2, the system firmware (e.g., UEFI firmware) of the CVM 308 loads the OS bootloader instead of the TPM loader 304. The OS bootloader boots the guest OS 306.

In the boot process of the guest OS 306, the guest OS 306 can write boot events to the vTPM's platform configuration registers (PCRs) and, if enabled, perform decryption of blocks read from a virtual disk using the DEK released from the vTPM. The DEK is part of the vTPM state decrypted by the SVSM 302. The guest OS 306 requests (at 454) the DEK from the vTPM in the SVSM 302. In response, the SVSM 302 sends (at 456) the DEK to the guest OS 306. The guest OS 306 uses the DEK to decrypt (at 458) data of code in the CVM 308. For example, the guest OS 306 can decrypt a storage volume, such as a boot volume containing boot code and data used for booting the CVM 308. The DEK can also be used to decrypt other data of any code in the CVM 308.

In examples where the TPM state key is based on a combination of the guest key from the CPU 142 and the external key from the key broker 146, a process including tasks 412, 414, 416, and 418 is performed. Tasks 412, 414, 416, and 418 are similar to respective tasks 322, 324, 326, and 328 in FIG. 1.

### Attestation and Remote Verification

TPM-based attestation can be performed after the guest OS 306 boots. The TPM-based attestation may be performed to ensure that the correct, expected OS install for the CVM 308 is launched. When the CVM 308 is first launched, a CVM launch measurement may be performed of just the memory pages up to and including the system firmware (e.g., UEFI firmware). The CVM launch measurement includes measuring (e.g., applying a hash function on) the foregoing memory pages of the CVM 308. The CVM launch measurement may not be sufficient to detect certain attacks performed by a privileged entity in the physical platform 100. A “privileged entity” refers to an entity in the physical platform 100 (FIG. 1) that has higher privileges than other entities in the physical platform 100.

For example, the hypervisor 140 (FIG. 1), or another privileged entity, if compromised may maliciously clone a CVM so that a restored vTPM state of the cloned CVM can be accessed by the compromised privileged entity. The restored the vTPM state for the vTPM in the cloned CVM can be used for unauthorized purposes.

In accordance with some examples of the present disclosure, a verifying entity (e.g., a verifying server or any other entity) can obtain a TEE attestation report that contains the e-EK generated at the last cold reset if the CVM. Software inside the CVM requests the TEE attestation report from the TEE and presents the TEE attestation report to the verifying entity. The TEE generates the report for the CVM, including information such as the measurement of the SVSM.

The verifying entity may be an entity in the physical platform 100 or an entity outside the physical platform 100. The verifying entity compares the e-EK against the e-EK held in the vTPM's nonvolatile memory. Also, because the e-EK is recorded in the vTPM using an extend operation, a record of past e-EKs is also retained, making it possible to also detect attacks in which a compromised privileged entity replaces the current TPM state on the virtual disk of the CVM with an old version. As noted above, the extend operation can calculate a hash value that is based on the current e-EK and any prior e-EK. If the current e-EK is replaced with a different e-EK, such as a prior e-EK, the hash value that is calculated would not match.

### Pre-Boot Attestation

In some examples, the TPM loader 304 can also perform attestation of the CVM at boot time of the CVM. The TPM loader 304 can control the restoration of the vTPM state from the vTPM in the CVM based on the attestation outcome. For example, if the verifying entity successfully verifies the e-EK in the vTPM, the verifying entity can instruct the key broker 146 to release a verification key to the TPM loader 304. The verification key may be the external key of FIG. 3 or 4, for example. The verification key can be provided to the SVSM 302 by issuing a vTPM set key command (similar to that issued at 326 in FIG. 3 or 416 in FIG. 4). Note that no additional vTPM set key commands would be accepted until the next hard reset of the physical platform 100.

Subsequently, in response to a vTPM state dump command (e.g., similar to that issued at 330 in FIG. 3) or a vTPM state load command (e.g., similar to that issued at 420 in FIG. 4), the SVSM 302 can combine the verification key with the guest key from the CPU 142. The combination can include an XOR operation applied to the guest key and the verification key, a hash function applied on the guest key and the verification key, or any other combination of the guest key and the verification key.

If the CVM is running on a CPU which does not support the generation of guest keys, the SVSM 302 may request that the verification key to be provided and, in that event, it would use the verification key alone as the TPM state key.

### Further Examples

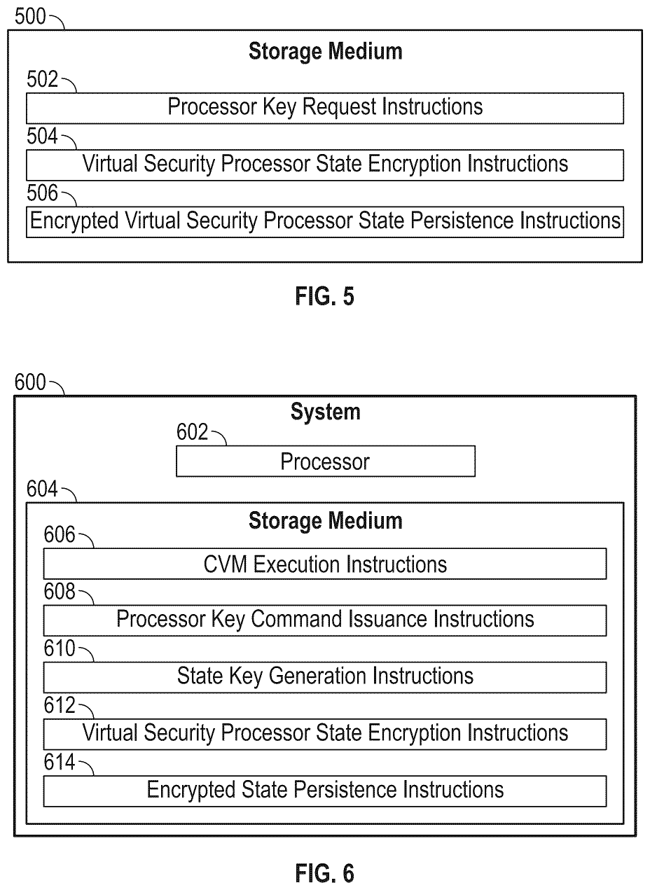

FIG. 5 is a block diagram of a non-transitory machine-readable or computer-readable storage medium 500 storing machine-readable instructions that upon execution cause a system to perform various tasks. An example of the system is the physical platform 100 of FIG. 1.

The machine-readable instructions include processor key request instructions 502 to request, by a secure service module that provides security services for a virtual compute entity, a key from a processor. An example of the processor is the CPU 142 of FIG. 1. An example of the secure service module is the SVSM 129 or 130 of FIG. 1 or the SVSM 302 of FIG. 3 or 4 that provides security services for VMs. A “secure service module” refers to a module implemented with machine-readable instructions that performs security services for a virtual compute entity such as a VM (e.g., the CVM 121 or 122 of FIG. 1) or another type of virtual compute entity such as a container. The secure service module may be part of a virtual compute entity such as a CVM.

The machine-readable instructions include virtual security processor state encryption instructions 504 to encrypt a state of a virtual security processor using the key to produce an encrypted virtual security processor state. For example, the virtual security processor includes a vTPM, and the encrypted virtual security processor state is an encrypted vTPM state.

The machine-readable instructions include encrypted virtual security processor state persistence instructions 506 to store the encrypted virtual security processor state in a persistent storage (e.g., 144 in FIG. 1). The persisted encrypted virtual security processor state is available at a later time (e.g., after a reset of the virtual compute entity such as a CVM) so that the virtual security processor state can be recovered for use.

In some examples, the virtual security processor state includes a data encryption key that is used to encrypt data of a trusted code in the system. The trusted code may execute in a CVM, for example.

In some examples, the data of the trusted code encrypted using the encryption key includes system firmware information of system firmware running in the CVM.

In some examples, the system firmware information encrypted using the encryption key includes EFI variables of UEFI code.

In some examples, the secure service module executes at a first privilege level (e.g., VM privilege level 0) that is higher (i.e., more privileged) than a privilege level (e.g., VM privilege level 1, 2, or 3) of an OS kernel.

In some examples, the first privilege level and the privilege level of the OS kernel are privilege levels in a TEE of a CVM.

In some examples, a module (e.g., a driver) associated with an OS of the CVM can issue a hypercall to the secure service module, where the hypercall. invokes a function of the secure service module along with a privilege level switch to a more privileged level of the CVM.

In some examples, the key from the processor is a first key. The secure service module can receive a second key provided by a key broker, such as the key broker 146 of FIG. 1. The secure service module combines the second key with the first key to produce an encryption key, and the state of the virtual security processor is encrypted uses the encryption key.

In some examples, the key is derived by the processor based on one or more of information in a program image for a CVM, or a measurement of instructions of the secure service module and the virtual security processor in the CVM, or a cryptographic key (e.g., a VCEK or VLEK) associated with the processor, or a privilege level at which the CVM executes.

In some examples, the machine-readable instructions can issue a request for loading the state of the virtual security processor in response to a reset of the virtual compute entity. The secure service module can obtain the key from the processor, and decrypt the encrypted virtual security processor state to produce a decrypted virtual security processor state.

FIG. 6 is a block diagram of a system 600, which may be implemented with one or more computers. The system 600 includes a processor 602 (or multiple processors). A processor can include a microprocessor, a core of a multi-core microprocessor, a microcontroller, a programmable integrated circuit, a programmable gate array, or another hardware processing circuit.

The system 600 includes a storage medium 604 storing machine-readable instructions executable on the processor 602 to perform various tasks. Machine-readable instructions executable on a hardware processor can refer to the instructions executable on a single hardware processor or the instructions executable on multiple hardware processors.

The machine-readable instructions in the storage medium 604 include CVM execution instructions 606 to execute a CVM including a secure service module at a first VM privilege level and a guest OS at a second VM privilege level that is less privileged than the first VM privilege level. The secure service module includes a virtual security processor, such as a vTPM.

The machine-readable instructions in the storage medium 604 include processor key command issuance instructions 608 to issue, by the guest OS, a command to the secure service module to obtain a processor key from the processor. The command may be the vTPM state dump command sent at 330 in FIG. 3, for example.

The machine-readable instructions in the storage medium 604 include state key generation instructions 610 to generate, by the secure service module, a state key based on the processor key. The state key may be the processor key, or may be based on a combination of the processor key and another key.

The machine-readable instructions in the storage medium 604 include virtual security processor state encryption instructions 612 to encrypt, by the secure service module, a state of the virtual security processor using the state key.

The machine-readable instructions in the storage medium 604 include encrypted state persistence instructions 614 to persist the encrypted state of the virtual security processor in a persistent storage.

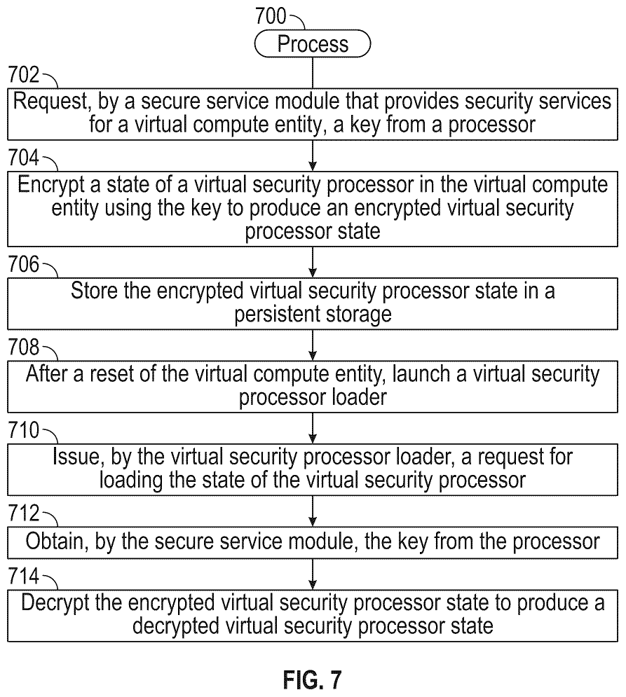

FIG. 7 is a flow diagram of a process 700, which may be performed in a physical platform implemented with one or more computers.

The process 700 includes requesting (at 702), by a secure service module that provides security services for a virtual compute entity such as a CVM, a key from a processor. The key can be the guest key discuss further above.

The process 700 includes encrypting (at 704) a state of a virtual security processor in the virtual compute entity using the key to produce an encrypted virtual security processor state. In some examples, the key from the processor can be used as an encryption key to encrypt the virtual security processor state. In other examples, the key from the processor can be combined with another key (such as from the key broker 146 in FIG. 1) to produce the encryption key for encrypting the virtual security processor state.

The process 700 includes storing (at 706) the encrypted virtual security processor state in a persistent storage. Storing the encrypted virtual security processor state causes the virtual security processor state to be persisted so that the virtual security processor state is available after a reset of the virtual compute entity.

The process 700 includes after a reset of the virtual compute entity, launching (at 708) a virtual security processor loader. An example of the virtual security processor loader is the TPM loader 123 or 124 of FIG. 1 or the TPM loader 304 of FIG. 3 or 4.

The process 700 includes issuing (at 710), by the virtual security processor loader, a request for loading the state of the virtual security processor. For example, the request can be the vTPM state load command of FIG. 4.

The process 700 includes obtaining (at 712), by the secure service module, the key from the processor.

The process 700 includes decrypting (at 714) the encrypted virtual security processor state to produce a decrypted virtual security processor state. Information of the decrypted virtual security processor state is accessible for use, such as to encrypt data of a trusted code.

In some examples, the process 700 includes loading ephemeral data and retaining a representation of ephemeral data as part of the loading of the state of the virtual security processor. The ephemeral data can include an e-EK of a vTPM, for example.

In examples with multiple CVMs, the multiple CVMs can include different e-EKs. The multiple CVMs may be created from the same CVM image.

As used herein, a “persistent storage” can be implemented with one or more storage devices that maintain stored data even if power were removed from a system in which the persistent storage is included. Examples of storage devices can include any or some combination of disk-based storage devices, solid-state drives, or other types of storage devices.

FIGS. 3, 4, and 7 show respective orders of tasks. In other examples, the tasks may be performed in a different order, some tasks may be omitted, and other tasks may be added.

A storage medium (e.g., 500 in FIG. 5 or 604 in FIG. 6) in which machine-readable instructions are stored can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
request, by a secure service module that provides security services for a virtual compute entity, a key from a processor;
encrypt a state of a virtual security processor using the key to produce an encrypted virtual security processor state; and
store the encrypted virtual security processor state in a persistent storage.

2. The non-transitory machine-readable storage medium of claim 1, wherein the virtual compute entity comprises a confidential virtual machine (CVM), and wherein the secure service module comprises a Secure Virtual Machine (VM) Service Module (SVSM) that provides security services for the CVM.

3. The non-transitory machine-readable storage medium of claim 1, wherein the state of the virtual security processor comprises a state of a virtual Trusted Platform Module (vTPM).

4. The non-transitory machine-readable storage medium of claim 1, wherein the state of the virtual security processor comprises an encryption key used to encrypt data of a trusted code in the system.

5. The non-transitory machine-readable storage medium of claim 4, wherein the trusted code executes in a confidential virtual machine (CVM).

6. The non-transitory machine-readable storage medium of claim 5, wherein the data of the trusted code encrypted using the encryption key comprises system firmware information of system firmware running in the CVM.

7. The non-transitory machine-readable storage medium of claim 6, wherein the system firmware information encrypted using the encryption key comprises Extensible Firmware Interface (EFI) variables of Universal Extensible Firmware Interface (UEFI) code.

8. The non-transitory machine-readable storage medium of claim 1, wherein the secure service module executes at a first privilege level that is higher than a privilege level of an operating system (OS) kernel.

9. The non-transitory machine-readable storage medium of claim 8, wherein the first privilege level and the privilege level of the OS kernel are privilege levels in a trusted execution environment (TEE) of a confidential VM (CVM).

10. The non-transitory machine-readable storage medium of claim 9, wherein the first privilege level is VM privilege level 0.

11. The non-transitory machine-readable storage medium of claim 10, wherein the CVM includes another entity running at a VM privilege level in the CVM that is less privileged than VM privilege level 0.

12. The non-transitory machine-readable storage medium of claim 1, wherein the secure service module is part of a confidential virtual machine (CVM), and wherein the instructions upon execution cause the system to:
issue, by a module associated with an operating system (OS) of the CVM, a hypercall to the secure service module, wherein the hypercall invokes a function of the secure service module along with a privilege level switch to a more privileged level of the CVM.

13. The non-transitory machine-readable storage medium of claim 1, wherein the key from the processor is a first key, and wherein the instructions upon execution cause the system to:
receive, by the secure service module, a second key provided by a key broker;
combine, by the secure service module, the second key with the first key to produce an encryption key,
wherein the encrypting of the state of the virtual security processor uses the encryption key.

14. The non-transitory machine-readable storage medium of claim 1, wherein the key is derived by the processor based on one or more of:
information in a program image for a confidential virtual machine (CVM), or
a measurement of instructions of the secure service module and the virtual security processor, or
a cryptographic key associated with the processor, or
a privilege level at which the CVM executes.

15. The non-transitory machine-readable storage medium of claim 1, wherein the instructions upon execution cause the system to:
issue a request for loading the state of the virtual security processor in response to a reset of the virtual compute entity;
obtain, by the secure service module, the key from the processor; and
decrypt the encrypted virtual security processor state to produce a decrypted virtual security processor state.

16. A method comprising:
requesting, by a secure service module that provides security services for a virtual compute entity, a key from a processor;
encrypting a state of a virtual security processor in the virtual compute entity using the key to produce an encrypted virtual security processor state;
storing the encrypted virtual security processor state in a persistent storage;
after a reset of the virtual compute entity comprising the virtual security processor, launching a virtual security processor loader;
issuing, by the virtual security processor loader, a request for loading the state of the virtual security processor;
obtaining, by the secure service module, the key from the processor; and
decrypting the encrypted virtual security processor state to produce a decrypted virtual security processor state.

17. The method of claim 16, further comprising:
loading ephemeral data and retaining a representation of ephemeral data as part of the loading of the state of the virtual security processor.

18. The method of claim 17, wherein the virtual compute entity comprises a confidential virtual machine (CVM), wherein the loaded ephemeral data includes an ephemeral endorsement key unique to the CVM, and wherein different ephemeral endorsement keys are assigned to different CVMs created from the same CVM image.

19. A system comprising:
a processor;
a non-transitory storage medium storing instructions executable on the processor to:
execute a confidential virtual machine (CVM) including a secure service module at a first VM privilege level and a guest operating system (OS) at a second VM privilege level that is less privileged than the first VM privilege level, wherein the secure service module comprises a virtual security processor,
issue, by the guest OS, a command to the secure service module to obtain a processor key from the processor,
generate, by the secure service module, a state key based on the processor key,
encrypt, by the secure service module, a state of the virtual security processor using the state key, and
persist the encrypted state of the virtual security processor in a persistent storage.

20. The system of claim 19, wherein the command is issued using a hypercall to the secure service module to trigger a privilege level switch from the second VM privilege level to the first VM privilege level.
